(19) United States
(12) Patent Application Publication
(10) Pub. No.: US 2026/0346478 A1
(43) Pub. Date: Nov. 5, 2026

(54) Adapter-Receiver Assembly for a Tooling Arm

(71) Applicant: Norgren Automation Solutions, LLC, Saline, MI (US)

(72) Inventors: Paul Jefferies, Pittsfield Township, MI (US); Richard Hamann, Pittsfield Township, MI (US); Ryan Konopka, Saline, MI (US); Michael Charlton, Saline (MI); Edwin E. Marttinen, Pinckney, MI (US)

(21) Appl. No.: 19/127,201

(22) PCT Filed: Nov. 6, 2023
(86) PCT No.: PCT/EP2023/080883

§ 371 Date: May 5, 2025

Related U.S. Application Data
(60) Provisional application No. 63/423,848, filed on Nov. 9, 2022.

(51) Int. Cl. B25J 15/04

(52) U.S. Cl. CPC B25J 15/0408

(57) ABSTRACT

An example assembly includes an adapter configured to be coupled to a tooling arm, wherein the adapter comprises a tapered proximal end; a receiver configured to receive the adapter therein, a split ring bushing disposed within the receiver, wherein the split ring bushing has a tapered interior surface; and a spring that biases the split ring bushing in a distal direction, wherein as the adapter is pushed in a proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

### BACKGROUND

In some industrial machinery, such as stamping presses, quick connect mounting arrangements are utilized to attach an adapter (to which a tooling arm can be coupled) to a mounting receiver without completely disassembling the mounting arrangement. One problem with such a quick connect mounting arrangement is that a relatively large space ahead of the mounting receiver is needed as the adapter is slid into the mounting receiver.

Further, when the adapter is mounted to the receiver, it may be desirable to ensure that there is no looseness between the adapter and the receiver. Any looseness can be amplified over a distance and may cause the tooling arm to rattle, which may be undesirable in some applications.

In some examples, a manual handle can be used to drive a fastener (e.g., a screw) to secure the adapter within the receiver. For example, as the handle is rotated, a threaded portion engages the adapter, minimizing the looseness of the adapter in the mounting receiver.

One drawback to such configuration is that an operator may forget to utilize the handle. If this occurs, the adapter may become loose in the mounting receiver during operation. It may thus be desirable to have a configuration that does not rely on manual or human action to secure the adapter within the receiver with minimal looseness. It is with respect to these and other considerations that the disclosure made herein is presented.

### SUMMARY

Within examples described herein, the present disclosure describes implementations that relate to an adapter-receiver assembly for a tooling arm, and methods and systems associated with the adapter-receiver assembly.

In a first example implementation, the present disclosure describes an assembly. The assembly includes: an adapter configured to be coupled to a tooling arm, wherein the adapter comprises: (i) a cylindrical body portion that has a lateral recess, (ii) a hole, and (iii) an adapter pin disposed through the hole, wherein the adapter pin comprises a conical tip; and a receiver configured to receive the adapter therein, wherein the receiver has a receiver body comprising: (i) a transversal opening configured to accommodate the lateral recess of the adapter, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction. The lateral recess of the adapter passes through the transversal opening of the receiver body to mount the adapter within the receiver, and the adapter is then pushed in a proximal direction within the receiver, such that the adapter pin is inserted into the pin cavity of the receiver body, pushing the collet in the proximal direction against the spring, wherein the conical tip of the adapter pin is received within the conical cavity of the collet, causing the collet to expand such that an exterior surface of the collet is pushed against an interior surface of the receiver body bounding the pin cavity, thereby securing the collet in-position and reducing looseness between the adapter and receiver.

In a second example implementation, the present disclosure describes an assembly. The assembly includes: an adapter configured to be coupled to a tooling arm, wherein the adapter comprises a tapered proximal end; a receiver configured to receive the adapter therein, a split ring bushing disposed within the receiver, wherein the split ring bushing has a split that enables the split ring bushing to expand, wherein the split ring bushing has a tapered interior surface; and a spring that biases the split ring bushing in a distal direction, wherein as the adapter is pushed in a proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

In a third example implementation, the present disclosure describes a receiver configured to receive an adapter coupled to a tooling arm therein. The receiver includes: a receiver body comprising: (i) a transversal opening, (ii) a pin cavity, (iii) a collet disposed within the pin cavity, wherein the collet is segmented to enable the collet to expand, wherein the collet has a conical cavity, and (iv) a first spring disposed within the pin cavity and biasing the collet in a distal direction; a receiver end plate attached to a proximal end of the receiver body; a split ring bushing disposed at an interface between the receiver body and the receiver end plate within the receiver, wherein the split ring bushing has a split that enables the split ring bushing to expand, wherein the split ring bushing has a tapered interior surface; and a second spring that biases the split ring bushing in a distal direction.

In a fourth example implementation, the present disclosure describes a method. The method includes: providing a receiver having a receiver body comprising: (i) a transversal opening, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction; providing an adapter configured to be coupled to a tooling arm, wherein the adapter comprises: (i) a cylindrical body portion that has a lateral recess, and (ii) an adapter pin comprising a conical tip; aligning the lateral recess of the adapter with the transversal opening of the receiver; moving the adapter transversely such that the lateral recess of the adapter passes through the transversal opening of the receiver body to position the adapter within the receiver body and align the adapter pin with the pin cavity of the receiver body; and pushing the adapter in a proximal direction within the receiver, thereby inserting the adapter pin into the pin cavity of the receiver body, such that the conical tip of the adapter pin is received within the conical cavity of the collet and the adapter pin pushes the collet in the proximal direction against the spring, causing the collet to expand such that an exterior surface of the collet is pushed against an interior surface of the receiver body bounding the pin cavity, securing the collet in-position and reducing looseness between the adapter and receiver.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a system for gripping and moving an object, in accordance with an example implementation.

FIG. 2 illustrates a perspective view of an assembly of an adapter and a receiver, in accordance with an example implementation.

FIG. 3 illustrates a perspective view of the adapter of FIG. 2, in accordance with an example implementation.

FIG. 4 illustrates a perspective view of the receiver of FIG. 2, in accordance with an example implementation.

FIG. 5 illustrates a perspective view of the adapter partially mounted to the receiver, in accordance with an example implementation.

FIG. 6 illustrates a perspective cross-sectional view of the assembly of FIG. 2, in accordance with an example implementation.

FIG. 7 illustrates an exploded perspective view of the assembly of FIG. 2, in accordance with an example implementation.

FIG. 8 illustrates a partial cross-sectional side view of the assembly of FIG. 2, in accordance with an example implementation.

FIG. 9A illustrates a perspective top view of a collet, in accordance with an example implementation.

FIG. 9B illustrates a perspective bottom view of the collet of FIG. 9A, in accordance with an example implementation.

FIG. 10 illustrates another exploded perspective view of the assembly of FIG. 2, in accordance with an example implementation.

FIG. 11 illustrates a partial cross-sectional side view of the assembly of FIG. 2, in accordance with an example implementation.

FIG. 12A illustrates a perspective view of a split ring bushing, in accordance with an example implementation.

FIG. 12B illustrates a partial cross sectional view of the split ring bushing of FIG. 12A, in accordance with an example implementation.

FIG. 13 illustrates a partial perspective view of a proximal end of the adapter of FIG. 3, in accordance with an example implementation.

FIG. 14 is a flowchart of a method for coupling the adapter of FIG. 2 to the receiver of FIG. 2, in accordance with an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

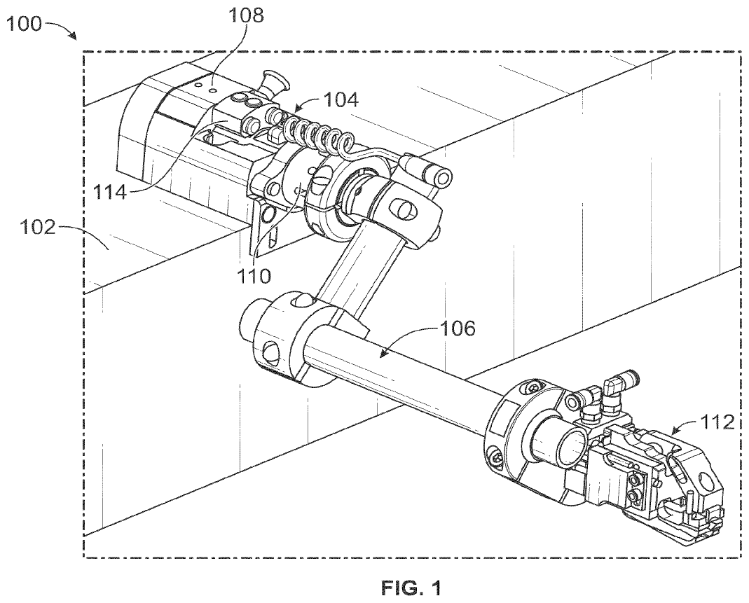

FIG. 1 illustrates a system 100 for gripping and moving an object, in accordance with an example implementation. As an example, the system 100 can be associated with a stamping press in an industrial facility. In this example, the object can be a panel that is to form a door or other panels of a vehicle, for instance.

The system 100 can have rails, such as rail 102 that are movable by an actuation system (not shown) to move the object (e.g., move the object between stations of the stamping press). An assembly 104 is used to mount a tooling arm 106 to the rail 102. The assembly 104 includes a receiver 108 mounted to the rail 102 and an adapter 110 that is mounted or received within the receiver 108.

Grippers or other types of end effectors are attached to the tooling arm 106 coupled to the assembly 104 to grip the object. For example, the tooling arm 106 has a gripper 112 attached to an end thereof. The gripper 112 grips the object to facilitate moving the object (e.g., from one station of a stamping press to another).

In some applications, during operation of the system 100, it may be desirable to reduce or eliminate any looseness or rattle at the assembly 104 because such looseness can be amplified along a length of the tooling arm 106 and may cause the object to also rattle undesirably. Further, such looseness may reduce the life of electrical connections (wires, pins, conductors, sockets, etc.). While manufacturing tolerances can be tightly controlled when making the adapters and receivers to reduce or eliminate looseness, such tight tolerance control can be costly. Even if manufacturing tolerances are controlled with cost, wear over time can increase looseness.

A manual mechanism can be included to allow an operator to tighten an adapter to a respective receiver. However, human operators may forget to use the mechanism or tightening the adapter might not be part of the operations implemented at a manufacturing facility. Further, mechanisms relying on operator action may be prone to operator error. It may thus be desirable to configure the assembly 104 in a cost-effective manner that reduces or eliminates any looseness without human intervention.

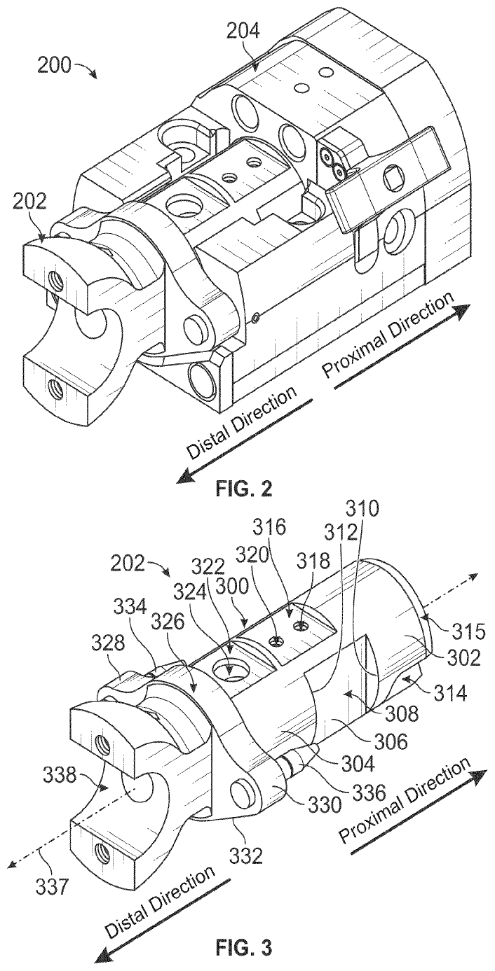

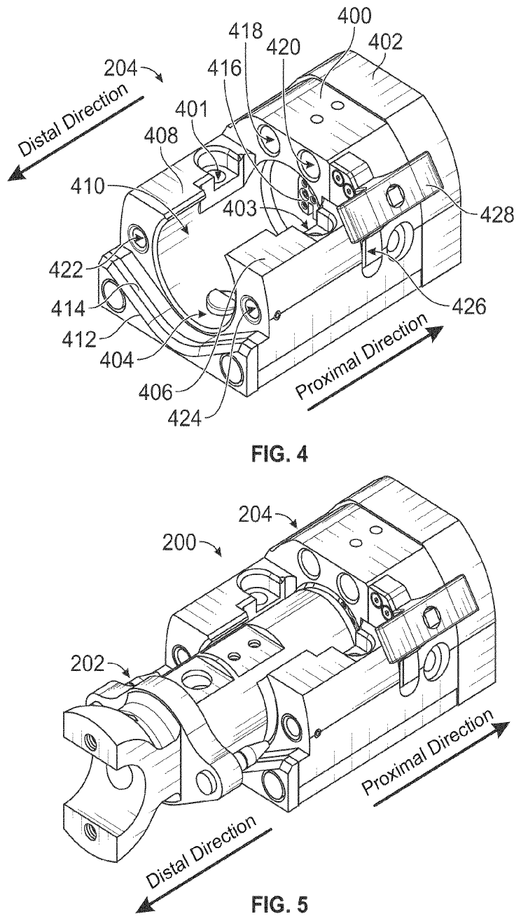

FIG. 2 illustrates a perspective view of an assembly 200 of an adapter 202 and a receiver 204, FIG. 3 illustrates a perspective view of the adapter 202, and FIG. 4 illustrates a perspective view of the receiver 204, in accordance with an example implementation. The assembly 200 can represent any of the assembly 104, described above. As such, the adapter 202 may represent the adapter 110 and the receiver 204 may represent the receiver 108.

Referring to FIG. 3, the adapter 202 has a cylindrical body portion 300 that is shaped generally as a cylinder. In an example, the adapter 202 can be substantially hollow.

The cylindrical body portion 300 has a proximal portion 302, a distal portion 304, and an intermediate portion 306 interposed longitudinally between the proximal portion 302 and the distal portion 304. The proximal portion 302 and the distal portion 304 are generally cylindrical with a similar diameter. The intermediate portion 306 has a lateral recess 308 that is bounded by a proximal surface 310 and a distal surface 312.

The proximal portion 302 has a depression, recess, or notch 314. The proximal portion 302 further includes a tapered proximal end 315

The intermediate portion 306 has a transverse recess 316 with a hole 318 and a hole 320. The holes 318, 320 can be threaded holes, for example, configured to receive a respective assembly including a pneumatic port. As described below, the transverse recess 316 is configured to receive a block (see block 114 in FIG. 1) that allows for air to flow to a gripper, such as the gripper 112, if the gripper is pneumatically actuated. The distal portion 304 has a transverse recess 322 having an electric port 324. Electric wires can be connected from an electric connector disposed in the receiver 204 (see electric connector 416 in FIG. 4) through the electric port 324 to a gripper, such as the gripper 112, if the gripper is electrically actuated or has sensors providing electric signals back to a controller.

The adapter 202 further includes a collar 326 coupled to or integrated with the distal portion 304 of the adapter 202. The collar 326 includes a pair of opposing flanges: a first flange 328 on a first side of the collar 326 and a second flange 330 on a second side of the collar 326, such that the second flange 330 is diametrically opposite from the first flange 328. The collar 326 further has a curved lower surface 332.

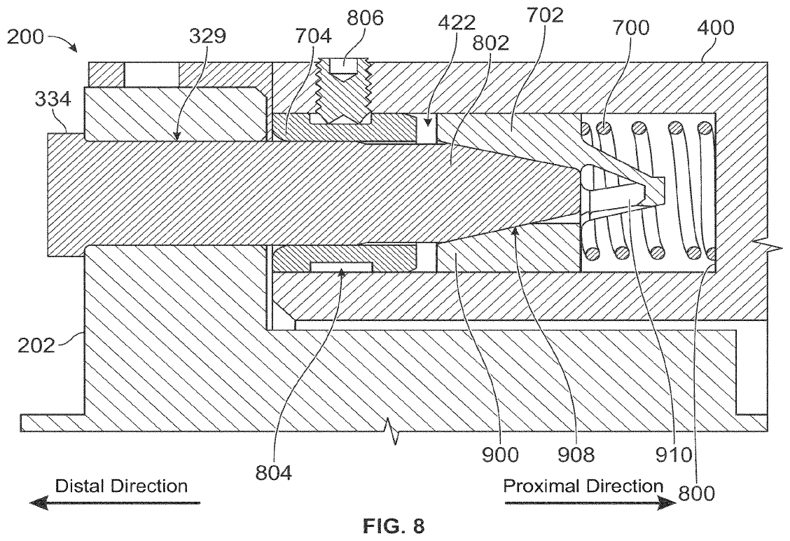

Further, as shown in FIG. 3, the first flange 328 has a first hole 329 (see FIGS. 7-8) through which a first adapter pin 334 is disposed. Similarly, the second flange 330 has a second hole 331 (see FIG. 7) through which a second adapter pin 336 is disposed. The adapter pins 334, 336 can be made of steel, as an example. The adapter pins 334, 336 are disposed substantially-parallel to a longitudinal axis 337 of the adapter 202. Although, two adapter pins are shown and described, in other examples, at least one adapter pin can be used. Further, the location of such adapter pin can be changed.

The adapter 202 further includes an interface 338 disposed at the distal end of the adapter 202 and coupled to or integral with the collar 326. The interface 338 enables the adapter to be coupled to a tooling arm (e.g., the tooling arm 106 shown in FIG. 1). The interface 338 shown in FIG. 3 can be referred to as a “half clamp,” but other interface configurations can be used based on the adapter type and the configuration of the tooling arm to which the adapter 202 is to be coupled. As examples, the interface 338 can take the form of a ball, a branch clamp, a stud, a flange face, a square clamp, a spline clamp, a tube, etc.

Referring to FIG. 4, the receiver 204 includes a receiver body 400 and a receiver end plate 402 attached to a proximal end of the receiver body 400. The receiver body 400 has a longitudinal cavity 404 that is configured to receive the adapter 202 therethrough. The receiver body 400 includes aperture 401 and aperture 403 configured to receive respective fasteners to secure the receiver 204 to the rail 102 shown in FIG. 1, for example.

A distal portion of the receiver body 400 has a pair of opposed spaced-apart flanges including flange 406 and flange 408, defining a transversal opening 410 therebetween. The transversal opening 410 has a dimension (e.g., width) greater than the respective dimension of the lateral recess 308 of the intermediate portion 306 of the adapter 202 such that the intermediate portion 306 can pass between the flanges 406, 408 of the receiver body 400 in a transverse direction (e.g., vertically in FIG. 4).

The inner dimensions (e.g., inner diameters of the interior peripheral surface of the receiver body 400 (e.g., the surface that bounds the longitudinal cavity 404) matches (e.g., substantially equals) the outer dimensions of the proximal portion 302 and the distal portion 304 of the adapter 202.

The receiver 204 has a guide portion 412 formed as a protrusion from a distal end of the receiver 204 and configured to guide the adapter 202 as it is being inserted into the receiver 204. In one example, the guide portion 412 is a separate component that is affixed to the receiver 204. In another example, the guide portion 412 is integral with the receiver body 400.

The guide portion 412 has a curved upper surface 414 (e.g., the guide portion 412 is concave) substantially shaped to correspond to the curved lower surface 332 of the collar 326 of the adapter 202. The curved upper surface 414 of the guide portion 412 is positioned slightly under the longitudinal cavity 404 of the receiver 204. When the adapter 202 is positioned in the receiver 204, the curved lower surface 332 of the collar 326 is received on the curved upper surface 414 of the guide portion 412.

In an example, the receiver 204 includes an electrical connector 416 mounted at the proximal end of the receiver 204. The electric connector 416 can be electrically coupled via wires/cables to a source of electric power, a controller, etc. In this example, when the adapter 202 is mounted in the receiver 204, wires can extend from the electrical connector 416 through the hollow interior of the adapter 202, then through the electric port 324 of the adapter 202. Wires can then be provided to a gripper (e.g., the gripper 112) to provide electric signals or electric power thereto, and receive electric signals therefrom (e.g., from sensors attached to the gripper 112).

In an example, the receiver 204 further includes a first pneumatic port 418 and a second pneumatic port 420. The pneumatic ports 418, 420 each receive an air supply tube from an air supply source. Further, the pneumatic ports 418, 420 may include check valves disposed therein.

As mentioned above with respect to FIG. 3, the adapter 202 includes the holes 318, 320 configured to receive a block (see block 114 shown in FIG. 1) therein. When the adapter 202 is inserted into the receiver 204, such block coupled to the adapter 202 actuates the check valves disposed in the pneumatic ports 418, 420 of the receiver 204, thereby allowing air flow to the block, and from the block to the gripper (e.g., the gripper 112).

In an example, the receiver body 400 includes a pin cavity 422 and a pin cavity 424. The pin cavities 422, 424 can be formed as generally cylindrical longitudinal cavities or blind holes formed in the receiver 204. The pin cavities 422, 424 are configured to receive the adapter pins 334, 336 when the adapter 202 is inserted into the receiver 204. As described in more details below, the receiver body 400 includes features disposed in the pin cavities 422, 424 that couples the adapter 202 to the receiver 204 in a manner that reduces or eliminates looseness therebetween. In an example, additionally or alternatively, as described below, the receiver end plate 402 can further include features that interact with the tapered proximal end 315 of the adapter 202 to reduce or eliminate looseness between the adapter 202 and the receiver 204.

The receiver 204 further includes an adapter retention mechanism 426 configured to retain the adapter 202 within the receiver 204. The adapter retention mechanism 426 has a handle 428. As described below, handle 428 is used to release the adapter 202 and allow the adapter 202 to be removed from the receiver 204.

To mount the adapter 202 within the receiver 204, the intermediate portion 306 of the adapter 202 can be aligned transversely with (e.g., can be positioned above) the transversal opening 410 between the flanges 406, 408 of the receiver body 400. The adapter 202 can then be moved transversely (e.g., dropped downward) to position the adapter 202 within the longitudinal cavity 404.

FIG. 5 illustrates a perspective view of the adapter 202 partially mounted to the receiver 204, in accordance with an example implementation. Particularly, FIG. 5 illustrates an intermediate step in coupling the adapter 202 to the receiver 204. As shown, the intermediate portion 306 of the adapter 202 has been aligned transversely with the transversal opening 410 and then moved transversely to position the adapter 202 within the longitudinal cavity 404. The following step is to push the adapter 202 in the proximal direction to fully mount and couple the adapter 202 to the receiver 204.

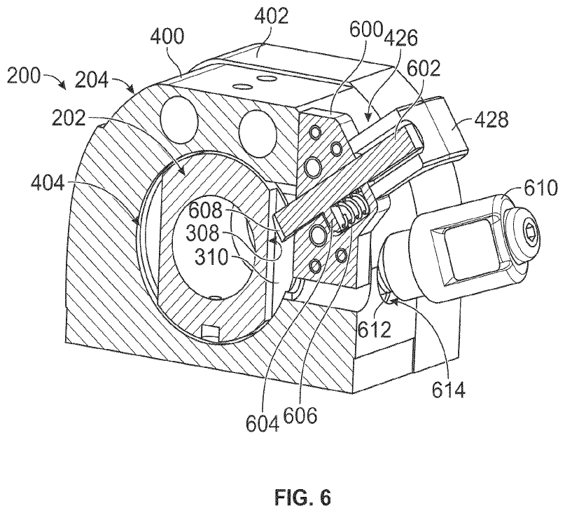

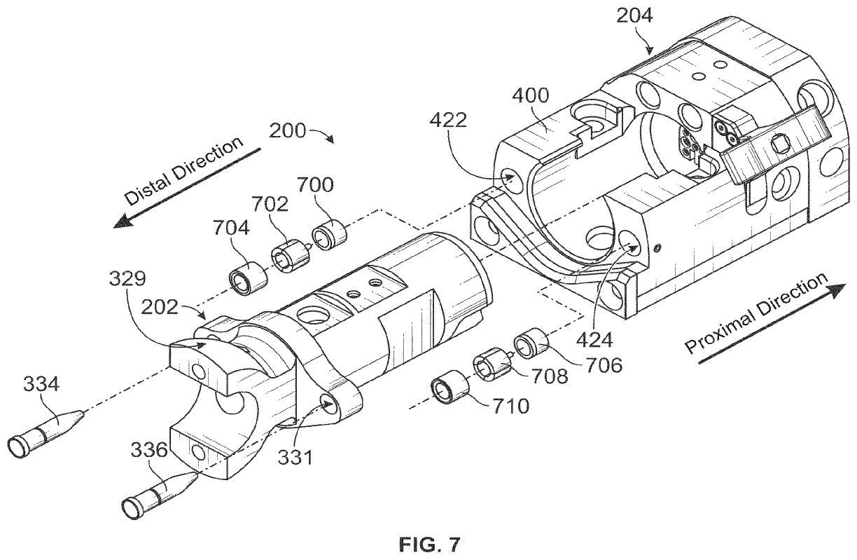

FIG. 6 illustrates a perspective cross-sectional view of the assembly 200, in accordance with an example implementation. The adapter retention mechanism 426 includes a housing 600 mounted, at least partially, within the receiver body 400. The housing 600 includes a cavity in which a dowel 602 is disposed, and the handle 428 is coupled to the dowel 602 and movable therewith. In an example, as depicted in FIG. 6, the dowel 602 is configured as a square or rectangular peg. However, other shapes are contemplated (e.g., cylindrical or other shapes).

The dowel 602 has a protrusion 604 configured as a spring cap or retainer for a spring 606 mounted in a spring cavity within the housing 600. The dowel 602 has a chamfered or tapered distal tip 608 configured to protrude into the longitudinal cavity 404 of the receiver 204.

When the adapter 202 is moved proximally in the longitudinal cavity 404 of the receiver 204, the tapered proximal end 315 of the adapter 202 pushes against a tapered surface of the tapered distal tip 608 of the dowel 602, thereby pushing the dowel 602 and the handle 428 outward. As the dowel 602 moves outward, the protrusion 604 compresses the spring 606 against an interior surface of the housing 600.

The adapter 202 can move proximally until the lateral recess 308 of the intermediate portion 306 of the adapter 202 is axially aligned with the dowel 602. Once the dowel 602 is aligned with the lateral recess 308, the spring 606 pushes the dowel 602 inward such that the dowel 602 extends into the lateral recess 308. The dowel 602 then interacts with the proximal surface 310 bounding the lateral recess 308 to preclude the adapter 202 from backing off in the distal direction. In other words, the dowel 602 locks or retains the adapter 202 in position.

When it is desired to remove the adapter 202 from the receiver 204, the handle 428 can be used by an operator to pull the dowel 602 outward against the spring 606. Once the dowel 602 is pulled out of the way and does not interface with the proximal surface 310, the adapter 202 is allowed to be pulled in the distal direction out of the longitudinal cavity 404 of the receiver 204.

In one example, the assembly 200 includes a handle 610 that can be rotated manually by an operator to secure the adapter 202 in position and reduce looseness of the adapter 202 in the receiver 204. For example, the handle 610 can have a cylindrical portion 612 that is threaded into an aperture 614 formed in the receiver body 400.

When the handle 610 is rotated in a particular direction (e.g., clockwise), the cylindrical portion 612 is screwed into the receiver body 400 and protrudes into the notch 314 (see FIG. 3) of the adapter 202 and contacts the exterior surface of the adapter 202, locking the adapter 202 in the receiver 204. When the handle 610 is rotated in an opposite direction (e.g., counter-clockwise), the cylindrical portion 612 moves out of the notch 314 away from the adapter 202, allowing the adapter 202 to be pulled out of the receiver 204.

While the handle 610 can be used to manually secure the adapter 202 within the receiver 204 and minimize looseness, it relies on human intervention. If an operator forgets to rotate the handle 610 (or if it is not the practice of some operators or operations to use the handle 610), some looseness can exist between the adapter 202 and the receiver 204 affecting operation of the system 100. It may thus be desirable to rely on alternative mechanisms to secure the adapter 202 within the receiver 204 without an extra step requiring operator action.

Particularly, as the adapter 202 is inserted into the receiver 204, the adapter pins 334, 336 are aligned with and are inserted into the pin cavities 422, 424 of the receiver 204. The receiver 204 includes features disposed in the pin cavities 422, 424 that capture the adapter pins 334, 336 and secures them in place to reduce looseness between the adapter 202 and the receiver 204.

FIG. 7 illustrates an exploded perspective view of the assembly 200, in accordance with an example implementation. The assembly 200 includes a spring 700, a collet 702, and a bushing 704 disposed in the pin cavity 422 of the receiver body 400 and configured to capture the adapter pin 334. Similarly, the assembly 200 includes a spring 706, a collet 708, and a bushing 710 disposed in the pin cavity 424 of the receiver body 400 and configured to capture the adapter pin 336.

FIG. 8 illustrates a partial cross-sectional side view of the assembly 200, in accordance with an example implementation. As depicted in FIG. 8, the pin cavity 422 can be generally cylindrical and formed as a blind hole bound by a proximal surface 800. The pin cavity 422 accommodates the spring 700, the collet 702, and the bushing 704 therein.

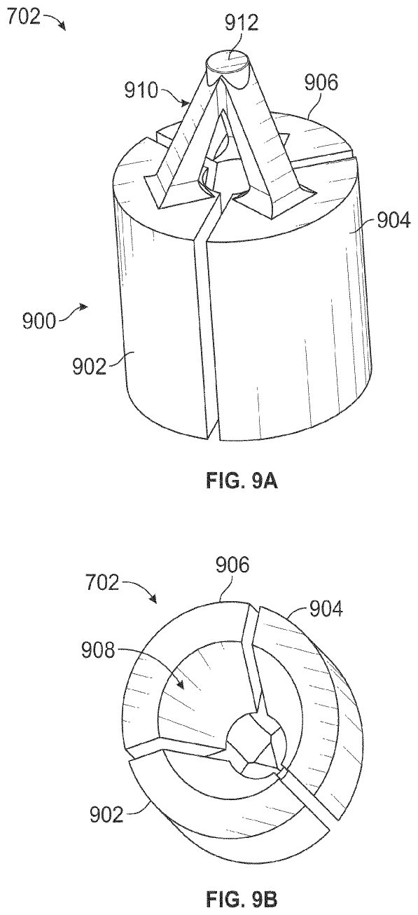

FIG. 9A illustrates a perspective top view of the collet 702, and FIG. 9B illustrates a perspective bottom view of the collet 702, in accordance with an example implementation. The collet 702 can also be referred to as a split bushing, segmented sleeve, or segmented collar. In an example, the collet 702 is made of a plastic material to enable the collet 702 to be flexible and capable of expanding.

The collet 702 has a cylindrical body portion 900 that is segmented or split longitudinally into multiple segments, such as segment 902, segment 904, and segment 906. More or fewer segments can be used.

Referring to FIG. 9B, the interior surfaces of the segments 902-906 are tapered such that the collet 702 has a conical cavity 908 formed therein. The conical cavity 908 is configured to receive and conform to a conical tip 802 of the adapter pin 334 as shown in FIG. 8.

The collet 702 further includes a proximal tip portion 910 with links connected respectively to the segments 902-906. As shown, the proximal tip portion 910 has a pyramid shape that converges into a proximal tip 912.

Referring back to FIG. 8, the proximal tip portion 910 is configured as a spring guide around which a distal portion of the spring 700 is disposed. The distal end of the spring 700 rests against a proximal surface of the cylindrical body portion 900 of the collet 702, whereas a proximal end of the spring 700 rests against the proximal surface 800 bounding the pin cavity 422.

When the adapter 202 is inserted in a transverse direction into the receiver 204, the adapter pin 334 is aligned with the pin cavity 422. The adapter 202 is then pushed into the proximal direction, such that the adapter pin 334 is inserted into the pin cavity 422. The bushing 704 operates as a guide for the adapter pin 334. Further, if the tooling arm (e.g., the tooling arm 106) applies a torque to the adapter 202, the bushing 704 may take or absorb such torque load from the adapter pin 334. The conical tip 802 of the adapter pin 334 is received within the conical cavity 908 of adapter pin 334.

The collet 702 can be configured such that a small clearance exists between its exterior surface and the interior surface of the receiver body 400 that bounds the pin cavity 422. The segmented or split configuration enables the collet 702 to expand when the adapter pin 334 is inserted into the pin cavity 422 and received within the collet 702.

Particularly, as the adapter pin 334 pushes against the collet 702 in the proximal direction while the spring 700 applies a force on the collet 702 in the distal direction, the collet 702 expands due to its split configuration. As the collet 702 expands, the clearance or space between the collet 702 and the interior surface of the receiver body 400 bounding the pin cavity 422 is filled by the collet 702. Thus, the exterior surface of the collet 702 is pushed against the interior surface of the receiver body 400 bounding the pin cavity 422, and the collet 702 is secured in-position.

FIG. 8 depicts the pin cavity 422 of the receiver 204 and the associated components (the spring 700, the collet 702, the bushing 704, and the adapter pin 334). The description above is also applicable to the pin cavity 424, the spring 706, the collet 708, the bushing 710, and the adapter pin 336, which operate in a similar manner. Thus, the collet 708 expands via the adapter pin 336 and is secured in position inside the pin cavity 424.

With both collets 702, 708 secured against interior surfaces within the receiver body 400, any looseness between the adapter 202 and the receiver 204 is reduced or eliminated. In some examples, only one adapter pin can be used.

When the adapter 202 is removed from the receiver 204, the spring 700 can push the collet 702 in the distal direction toward the bushing 704. To preclude the bushing 704 from being ejected out of the pin cavity 422, the bushing 704 has an annular exterior groove 804 configured to receive a retaining screw 806 disposed partially through the receiver body 400. With this configuration, the retaining screw 806 retains the bushing 704 to the receiver body 400 and precludes it from being ejected.

Additionally or alternatively, the assembly 200 includes other features at the interface between the receiver body 400 and the receiver end plate 402 that reduce or eliminate looseness between the adapter 202 and the receiver 204.

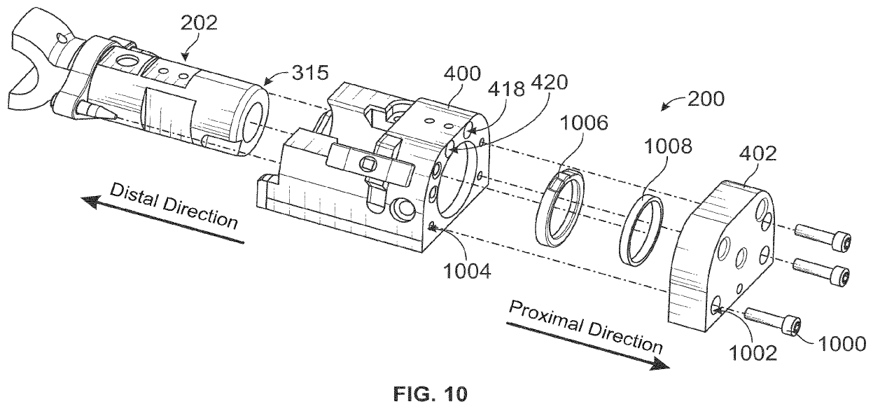

FIG. 10 illustrates another exploded perspective view of the assembly 200, in accordance with an example implementation. As shown, the assembly 200 includes a plurality of fasteners, such as fastener 1000 configured to couple the receiver end plate 402 to the receiver body 400. For example, the fastener can be inserted through a hole 1002 in the receiver end plate 402 and then threaded into a threaded hole 1004 in the receiver body 400 aligned with the hole 1002. This way, the receiver end plate 402 can be affixed to the receiver body 400.

At the interface between the receiver body 400 and the receiver end plate 402, the assembly includes a split ring bushing 1006 and a spring 1008. In the example implementation shown in FIG. 10, the spring 1008 is a multi-loop wave spring. A wave spring is used as an example, and other types of the springs (e.g., coil spring, a frusto-conical or cup-shaped washer, etc.) could be used. The split ring bushing 1006 and the spring 1008 further locks the adapter 202 to the receiver 204 to reduce or eliminate looseness.

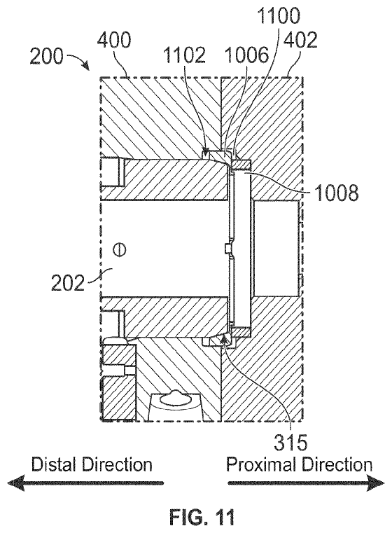

FIG. 11 illustrates a partial cross-sectional side view of the assembly 200, in accordance with an example implementation. As shown in FIG. 11, the receiver end plate 402 has a stepped cavity 1100 at its distal end configured to receive and accommodate the spring 1008 therein.

The receiver body 400 has a an annular groove 1102 configured to receive a portion of the split ring bushing 1006, while another portion of the split ring bushing 1006 is received within the stepped cavity 1100 of the receiver end plate 402. In other words, the split ring bushing 1006 is disposed partially within the receiver body 400 and partially within the receiver end plate 402. The split ring bushing 1006 is configured such that there is a slight clearance between its exterior surface and the interior surface of the receiver body 400 bounding the annular groove 1102.

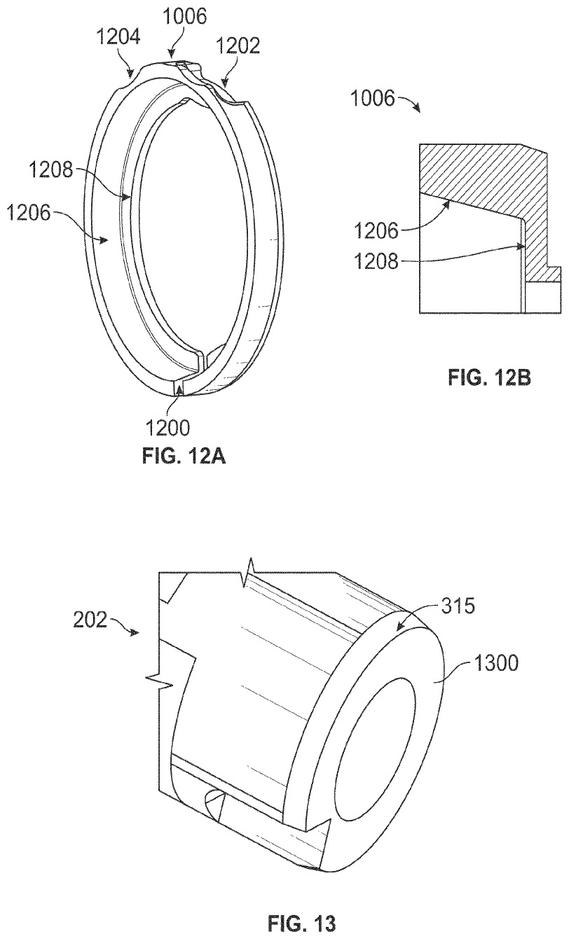

FIG. 12A illustrates a perspective view of the split ring bushing 1006, and FIG. 12B illustrates a partial cross sectional view of the split ring bushing 1006, in accordance with an example implementation. As depicted, the split ring bushing 1006 is ring-shaped and is segmented or has a split 1200 (opening or fissure) that allows the split ring bushing 1006 to expand. The split ring bushing 1006 further includes a first depression 1202 and a second depression 1204. In the examples where the receiver 204 includes check valves disposed in the pneumatic ports 418, 420 of the receiver 204, the depressions 1202, 1204 accommodate such check valves. The split ring bushing 1006 further has a tapered interior surface 1206 and a flange 1208 against which the spring 1008 rests.

FIG. 13 illustrates a partial perspective view of a proximal end of the adapter 202, in accordance with an example implementation. As depicted, the adapter 202 has the tapered proximal end 315 and a proximal surface 1300 that is substantially flat. When the adapter 202 is inserted into the receiver 204, the adapter 202 is moved proximally until the tapered proximal end 315 is received within the split ring bushing 1006 and interfaces with the tapered interior surface 1206 of the split ring bushing 1006.

Referring back to FIG. 11, when the adapter 202 is inserted into the receiver 204 to the position shown in FIG. 11, the adapter 202 pushes against the split ring bushing 1006 in the proximal direction while the spring 1008 applies a force on the split ring bushing 1006 in the distal direction. As such, the split ring bushing 1006 expands due to its split configuration.

As the split ring bushing 1006 expands, its exterior surface is pushed against the interior surface of the receiver body 400 bounding the annular groove 1102. This way, the split ring bushing 1006 secured against the interior surface of the receiver body 400 bounding the annular groove 1102.

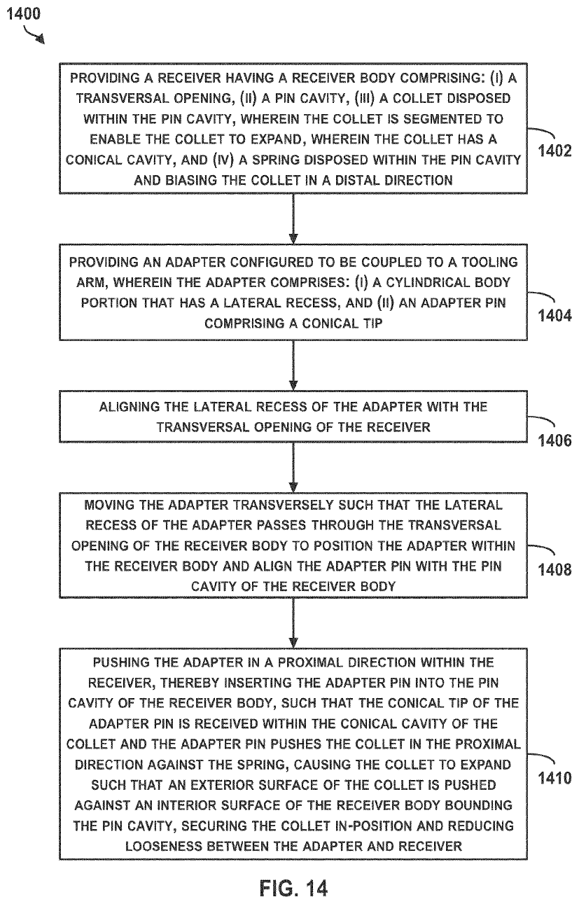

FIG. 14 is a flowchart of a method 1400 for coupling the adapter 202 to the receiver 204, in accordance with an example implementation. As such, the method 1400 is for forming the assembly 200. The method 1400 may include one or more operations, functions, or actions as illustrated by one or more of blocks 1402-1410.

Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 1402, the method 1400 includes providing the receiver 204 having the receiver body 400 comprising: (i) the transversal opening 410, (ii) the pin cavity 422, (iii) the collet 702 disposed within the pin cavity 422, wherein the collet 702 is segmented to enable the collet 702 to expand, wherein the collet 702 has the conical cavity 908, and (iv) the spring 700 disposed within the pin cavity 422 and biasing the 702 collet in a distal direction.

The term “providing” as used herein, and for example with regard to the receiver 204 or other components, includes any action to make the receiver 204 or any other component available for use, such as bringing the receiver 204 to an apparatus or to a work environment for further processing (e.g., mounting other components, etc.).

At block 1404, the method 1400 includes providing the adapter 202 configured to be coupled to a tooling arm (e.g., the tooling arm 106), wherein the adapter 202 comprises: (i) the cylindrical body portion 300 that has the lateral recess 308, and (ii) the adapter pin 334 comprising the conical tip 802.

At block 1406, the method 1400 includes aligning the lateral recess 308 of the adapter 202 with the transversal opening 410 of the receiver 204.

At block 1408, the method 1400 includes moving the adapter 202 transversely such that the lateral recess 308 of the adapter 202 passes through the transversal opening 410 of the receiver body 400 to position the adapter 202 within the receiver body 400 and align the adapter pin 334 with the pin cavity 422 of the receiver body 400.

At block 1410, the method 1400 includes pushing the adapter 202 in a proximal direction within the receiver 204, thereby inserting the adapter pin 334 into the pin cavity 422 of the receiver body 400, such that the conical tip 802 of the adapter pin 334 is received within the conical cavity 908 of the collet 702 and the adapter pin 334 pushes the collet 702 in the proximal direction against the spring 700, causing the collet 702 to expand such that an exterior surface of the collet 702 is pushed against an interior surface of the receiver body 400 bounding the pin cavity 422, securing the collet 702 in-position and reducing looseness between the adapter 202 and receiver 204.

The method 1400 can include other steps as well. For instance, the method 1400 can further include aligning the second adapter pin 336 with the second pin cavity 424 of the receiver body 400; and inserting the second adapter pin 336 into the second pin cavity 424 of the receiver body 400 as the adapter 202 is pushed in the proximal direction within the receiver 204, such that a respective conical tip of the second adapter pin 336 is received within the respective conical cavity of the collet 708 and the second adapter pin 336 pushes the collet 708 in the proximal direction against the spring 706, causing the collet 708 to expand such that an exterior surface of the collet 708 is pushed against the interior surface of the receiver body 400 bounding the second pin cavity 424, securing the collet 708 in-position and reducing looseness between the adapter 202 and receiver 204.

The method 1400 can further include, as the adapter 202 is pushed in the proximal direction within the receiver 204, inserting the tapered proximal end 315 of the cylindrical body portion 300 of the adapter 202 into the split ring bushing 1006 such that tapered proximal end 315 interfaces with the tapered interior surface 1206 of the split ring bushing 1006, causing the split ring bushing 1006 to expand against an interior surface of the receiver 204, thereby securing the split ring bushing 1006 in-position and reducing looseness between the adapter 202 and receiver 204. The method 1400 can further include other steps as described throughout herein.

Implementations of the present disclosure can thus relate to one of the enumerated example embodiments (EEEs) listed below.

EEE 1 is an assembly comprising: an adapter configured to be coupled to a tooling arm, wherein the adapter comprises: (i) a cylindrical body portion that has a lateral recess, (ii) a hole, and (iii) an adapter pin disposed through the hole, wherein the adapter pin comprises a conical tip; and a receiver configured to receive the adapter therein, wherein the receiver has a receiver body comprising: (i) a transversal opening configured to accommodate the lateral recess of the adapter, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction, wherein: the lateral recess of the adapter passes through the transversal opening of the receiver body to mount the adapter within the receiver, and the adapter is then pushed in a proximal direction within the receiver, such that the adapter pin is inserted into the pin cavity of the receiver body, pushing the collet in the proximal direction against the spring, wherein the conical tip of the adapter pin is received within the conical cavity of the collet, causing the collet to expand such that an exterior surface of the collet is pushed against an interior surface of the receiver body bounding the pin cavity, thereby securing the collet in-position and reducing looseness between the adapter and receiver.

EEE 2 is the assembly of EEE 1, wherein the hole is a first hole, wherein the adapter pin is a first adapter pin, wherein the pin cavity is a first pin cavity, wherein the spring is a first spring, wherein the collet is a first collet, wherein: the adapter further comprises a second hole and a second adapter pin disposed through the second hole, wherein the second adapter pin has a respective conical tip, the receiver body comprises a second pin cavity having a second spring and a second collet disposed therein, wherein the second spring biases the second collet in the distal direction, wherein the second collet is segmented to enable the second collet to expand, wherein the second collet has a respective conical cavity, and as the adapter is pushed in the proximal direction within the receiver, the second adapter pin is inserted into the second pin cavity of the receiver, pushing the second collet in the proximal direction against the second spring, wherein the respective conical tip of the second adapter pin is received within the respective conical cavity of the second collet, causing the second collet to expand such that an exterior surface of the second collet is pushed against the interior surface of the receiver body bounding the second pin cavity, thereby securing the second collet in-position and reducing looseness between the adapter and receiver.

EEE 3 is the assembly of EEE 2, wherein the adapter further comprises a collar disposed at a distal end of the cylindrical body portion of the adapter, wherein the collar comprises a first flange and a second flange, wherein the first flange comprises the hole through which the first adapter pin is disposed, wherein the second flange comprises the second hole through which the second adapter pin is disposed, and wherein the first adapter pin and the second adapter pin are disposed parallel to a longitudinal axis of the adapter.

EEE 4 is the assembly of any of EEEs 1-3, wherein the collet is configured as a split bushing having a cylindrical body portion that is segmented into multiple segments, wherein respective interior surfaces of the multiple segments are tapered to form the conical cavity that receives the conical tip of the adapter pin.

EEE 5 is the assembly of EEE 4, wherein the collet further comprises a proximal tip portion with links connected respectively to the multiple segments, wherein the proximal tip portion is configured as a spring guide around which a distal portion of the spring is disposed, wherein a distal end of the spring rests against a proximal surface of the cylindrical body portion of the collet, and wherein a proximal end of the spring rests against a proximal surface of the receiver bounding the pin cavity.

EEE 6 is the assembly of any of EEEs 1-5, further comprising: a bushing disposed within the pin cavity, distal from the collet, wherein the adapter pin is disposed through the bushing, wherein the bushing comprises an annular exterior groove that receives a retaining screw disposed partially through the receiver body, thereby retaining the bushing to the receiver body.

EEE 7 is the assembly of any of EEEs 1-6, wherein the spring is a first spring, wherein the receiver further comprises: a receiver end plate attached to a proximal end of the receiver body, wherein the assembly further comprises a split ring bushing and a second spring disposed at an interface between the receiver body and the receiver end plate, wherein the second spring biases the split ring bushing in the distal direction, wherein the split ring bushing has a split that enables the split ring bushing to expand, wherein the split ring bushing has a tapered interior surface, wherein the adapter has a tapered proximal end, and wherein as the adapter is pushed in the proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

EEE 8 is an assembly comprising: an adapter configured to be coupled to a tooling arm, wherein the adapter comprises a tapered proximal end; a receiver configured to receive the adapter therein, a split ring bushing disposed within the receiver, wherein the split ring bushing has a split that enables the split ring bushing to expand, wherein the split ring bushing has a tapered interior surface; and a spring that biases the split ring bushing in a distal direction, wherein as the adapter is pushed in a proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

EEE 9 is the assembly of EEE 8, wherein the adapter comprises a cylindrical body portion having the tapered proximal end.

EEE 10 is the assembly of EEE 9, wherein the cylindrical body portion has a lateral recess, wherein the receiver has a receiver body comprising a transversal opening configured to accommodate the lateral recess of the adapter, wherein the lateral recess of the adapter passes through the transversal opening of the receiver body to mount the adapter within the receiver, before pushing the adapter in the proximal direction within the receiver.

EEE 11 is the assembly of any of EEEs 8-10, wherein the receiver has a receiver body and a receiver end plate attached to a proximal end of the receiver body, wherein the split ring bushing and the spring are disposed at an interface between the receiver body and the receiver end plate.

EEE 12 is the assembly of any of EEEs 8-11, wherein the spring is a multi-loop wave spring.

EEE 13 is a receiver configured to receive an adapter coupled to a tooling arm therein, the receiver comprising: a receiver body comprising: (i) a transversal opening, (ii) a pin cavity, (iii) a collet disposed within the pin cavity, wherein the collet is segmented to enable the collet to expand, wherein the collet has a conical cavity, and (iv) a first spring disposed within the pin cavity and biasing the collet in a distal direction; a receiver end plate attached to a proximal end of the receiver body; a split ring bushing disposed at an interface between the receiver body and the receiver end plate within the receiver, wherein the split ring bushing has a split that enables the split ring bushing to expand, wherein the split ring bushing has a tapered interior surface; and a second spring that biases the split ring bushing in a distal direction.

EEE 14 is the receiver of EEE 13, wherein the pin cavity is a first pin cavity, wherein the collet is a first collet, wherein the receiver body comprises a second pin cavity having a third spring and a second collet disposed therein, wherein the third spring biases the second collet in the distal direction, wherein the second collet is segmented to enable the second collet to expand, wherein the second collet has a respective conical cavity.

EEE 15 is the receiver of any of EEEs 13-14, wherein the collet is configured as a split bushing having a cylindrical body portion that is segmented into multiple segments, wherein respective interior surfaces of the multiple segments are tapered to form the conical cavity.

EEE 16 is the receiver of EEE 15, wherein the collet further comprises a proximal tip portion with links connected respectively to the multiple segments, wherein the proximal tip portion is configured as a spring guide around which a distal portion of the first spring is disposed, wherein a distal end of the first spring rests against a proximal surface of the cylindrical body portion of the collet, and wherein a proximal end of the first spring rests against a proximal surface of the receiver bounding the pin cavity.

EEE 17 is the receiver of any of EEEs 13-16, further comprising: a bushing disposed within the pin cavity, distal from the collet, wherein the bushing comprises an annular exterior groove that receives a retaining screw disposed partially through the receiver body, thereby retaining the bushing to the receiver body.

EEE 18 is a method comprising: providing a receiver having a receiver body comprising: (i) a transversal opening, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction; providing an adapter configured to be coupled to a tooling arm, wherein the adapter comprises: (i) a cylindrical body portion that has a lateral recess, and (ii) an adapter pin comprising a conical tip; aligning the lateral recess of the adapter with the transversal opening of the receiver; moving the adapter transversely such that the lateral recess of the adapter passes through the transversal opening of the receiver body to position the adapter within the receiver body and align the adapter pin with the pin cavity of the receiver body; and pushing the adapter in a proximal direction within the receiver, thereby inserting the adapter pin into the pin cavity of the receiver body, such that the conical tip of the adapter pin is received within the conical cavity of the collet and the adapter pin pushes the collet in the proximal direction against the spring, causing the collet to expand such that an exterior surface of the collet is pushed against an interior surface of the receiver body bounding the pin cavity, securing the collet in-position and reducing looseness between the adapter and receiver.

EEE 19 is the method of EEE 18, wherein the adapter pin is a first adapter pin, wherein the pin cavity is a first pin cavity, wherein the spring is a first spring, wherein the collet is a first collet, wherein the adapter further comprises a second adapter pin, wherein the second adapter pin has a respective conical tip, wherein the receiver body comprises a second pin cavity having a second spring and a second collet disposed therein, wherein the second spring biases the second collet in the distal direction, wherein the second collet is segmented to enable the second collet to expand, wherein the second collet has a respective conical cavity, wherein the method further comprises: aligning the second adapter pin with the second pin cavity of the receiver body; and inserting the second adapter pin into the second pin cavity of the receiver body as the adapter is pushed in the proximal direction within the receiver, such that the respective conical tip of the second adapter pin is received within the respective conical cavity of the second collet and the second adapter pin pushes the second collet in the proximal direction against the second spring, causing the second collet to expand such that an exterior surface of the second collet is pushed against the interior surface of the receiver body bounding the second pin cavity, securing the second collet in-position and reducing looseness between the adapter and receiver.

EEE 20 is the method of any of EEEs 18-19, wherein the spring is a first spring, wherein the receiver further comprises a split ring bushing and a second spring biasing the split ring bushing in the distal direction, wherein the split ring bushing has a split that enables the split ring bushing to expand, wherein the split ring bushing has a tapered interior surface, wherein the cylindrical body portion of the adapter has a tapered proximal end, and wherein the method further comprises: as the adapter is pushed in the proximal direction within the receiver, inserting the tapered proximal end of the cylindrical body portion of the adapter into the split ring bushing such that tapered proximal end interfaces with the tapered interior surface of the split ring bushing, causing the split ring bushing to expand against an interior surface of the receiver, thereby securing the split ring bushing in-position and reducing looseness between the adapter and receiver.

What is claimed is:

1. An assembly comprising:
an adapter configured to be coupled to a tooling arm, wherein the adapter comprises: (i) a cylindrical body portion that has a lateral recess, (ii) a hole, and (iii) an adapter pin disposed through the hole, wherein the adapter pin comprises a conical tip; and
a receiver configured to receive the adapter therein, wherein the receiver has a receiver body comprising: (i) a transversal opening configured to accommodate the lateral recess of the adapter, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction, wherein:
the lateral recess of the adapter passes through the transversal opening of the receiver body to mount the adapter within the receiver, and the adapter is then pushed in a proximal direction within the receiver, such that the adapter pin is inserted into the pin cavity of the receiver body, pushing the collet in the proximal direction against the spring, wherein the conical tip of the adapter pin is received within the conical cavity of the collet, causing the collet to expand such that an exterior surface of the collet is pushed against an interior surface of the receiver body bounding the pin cavity, thereby securing the collet in-position and reducing looseness between the adapter and receiver.

2. The assembly of claim 1, wherein the hole is a first hole, wherein the adapter pin is a first adapter pin, wherein the pin cavity is a first pin cavity, wherein the spring is a first spring, wherein the collet is a first collet, wherein:
the adapter further comprises a second hole and a second adapter pin disposed through the second hole, wherein the second adapter pin has a respective conical tip,
the receiver body comprises a second pin cavity having a second spring and a second collet disposed therein, wherein the second spring biases the second collet in the distal direction, wherein the second collet is segmented to enable the second collet to expand, wherein the second collet has a respective conical cavity, and
as the adapter is pushed in the proximal direction within the receiver, the second adapter pin is inserted into the second pin cavity of the receiver, pushing the second collet in the proximal direction against the second spring, wherein the respective conical tip of the second adapter pin is received within the respective conical cavity of the second collet, causing the second collet to expand such that an exterior surface of the second collet is pushed against the interior surface of the receiver body bounding the second pin cavity, thereby securing the second collet in-position and reducing looseness between the adapter and receiver.

3. The assembly of claim 2, wherein the adapter further comprises a collar disposed at a distal end of the cylindrical body portion of the adapter, wherein the collar comprises a first flange and a second flange, wherein the first flange comprises the hole through which the first adapter pin is disposed, wherein the second flange comprises the second hole through which the second adapter pin is disposed, and wherein the first adapter pin and the second adapter pin are disposed parallel to a longitudinal axis of the adapter.

4. The assembly of claim 1, wherein the collet is configured as a split bushing having a cylindrical body portion that is segmented into multiple segments, wherein respective interior surfaces of the multiple segments are tapered to form the conical cavity that receives the conical tip of the adapter pin.

5. The assembly of claim 4, wherein the collet further comprises a proximal tip portion with links connected respectively to the multiple segments, wherein the proximal tip portion is configured as a spring guide around which a distal portion of the spring is disposed, wherein a distal end of the spring rests against a proximal surface of the cylindrical body portion of the collet, and wherein a proximal end of the spring rests against a proximal surface of the receiver bounding the pin cavity.

6. The assembly of claim 1, further comprising:
a bushing disposed within the pin cavity, distal from the collet, wherein the adapter pin is disposed through the bushing, wherein the bushing comprises an annular exterior groove that receives a retaining screw disposed partially through the receiver body, thereby retaining the bushing to the receiver body.

7. The assembly of claim 1, wherein the spring is a first spring, wherein the receiver further comprises:
a receiver end plate attached to a proximal end of the receiver body, wherein the assembly further comprises a split ring bushing and a second spring disposed at an interface between the receiver body and the receiver end plate, wherein the second spring biases the split ring bushing in the distal direction, wherein the split ring bushing has a split that enables the split ring bushing to expand, wherein the split ring bushing has a tapered interior surface, wherein the adapter has a tapered proximal end, and wherein as the adapter is pushed in the proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

8. An assembly comprising:
an adapter configured to be coupled to a tooling arm, wherein the adapter comprises a tapered proximal end;
a receiver configured to receive the adapter therein,
a split ring bushing disposed within the receiver, wherein the split ring bushing has a split that enables the split ring bushing to expand, wherein the split ring bushing has a tapered interior surface; and
a spring that biases the split ring bushing in a distal direction, wherein as the adapter is pushed in a proximal direction within the receiver, the tapered proximal end of the adapter is received within the split ring bushing and interfaces with the tapered interior surface of the split ring bushing, causing the split ring bushing to expand against an interior surface of the receiver, thereby securing the split ring bushing in-position and reducing looseness between the adapter and receiver.

9. The assembly of claim 8, wherein the adapter comprises a cylindrical body portion having the tapered proximal end.

10. The assembly of claim 9, wherein the cylindrical body portion has a lateral recess, wherein the receiver has a receiver body comprising a transversal opening configured to accommodate the lateral recess of the adapter, wherein the lateral recess of the adapter passes through the transversal opening of the receiver body to mount the adapter within the receiver, before pushing the adapter in the proximal direction within the receiver.

11. The assembly of claim 8, wherein the receiver has a receiver body and a receiver end plate attached to a proximal end of the receiver body, wherein the split ring bushing and the spring are disposed at an interface between the receiver body and the receiver end plate.

12. The assembly of claim 8, wherein the spring is a multi-loop wave spring.

13. A receiver configured to receive an adapter coupled to a tooling arm therein, the receiver comprising:
a receiver body comprising: (i) a transversal opening, (ii) a pin cavity, (iii) a collet disposed within the pin cavity, wherein the collet is segmented to enable the collet to expand, wherein the collet has a conical cavity, and (iv) a first spring disposed within the pin cavity and biasing the collet in a distal direction;
a receiver end plate attached to a proximal end of the receiver body;
a split ring bushing disposed at an interface between the receiver body and the receiver end plate within the receiver, wherein the split ring bushing has a split that enables the split ring bushing to expand, wherein the split ring bushing has a tapered interior surface; and
a second spring that biases the split ring bushing in a distal direction.

14. The receiver of claim 13, wherein the pin cavity is a first pin cavity, wherein the collet is a first collet, wherein the receiver body comprises a second pin cavity having a third spring and a second collet disposed therein, wherein the third spring biases the second collet in the distal direction, wherein the second collet is segmented to enable the second collet to expand, wherein the second collet has a respective conical cavity.

15. The receiver of claim 13, wherein the collet is configured as a split bushing having a cylindrical body portion that is segmented into multiple segments, wherein respective interior surfaces of the multiple segments are tapered to form the conical cavity.

16. The receiver of claim 15, wherein the collet further comprises a proximal tip portion with links connected respectively to the multiple segments, wherein the proximal tip portion is configured as a spring guide around which a distal portion of the first spring is disposed, wherein a distal end of the first spring rests against a proximal surface of the cylindrical body portion of the collet, and wherein a proximal end of the first spring rests against a proximal surface of the receiver bounding the pin cavity.

17. The receiver of claim 13, further comprising:
a bushing disposed within the pin cavity, distal from the collet, wherein the bushing comprises an annular exterior groove that receives a retaining screw disposed partially through the receiver body, thereby retaining the bushing to the receiver body.

18. A method comprising:
providing a receiver having a receiver body comprising: (i) a transversal opening, (ii) a pin cavity, (iii) a collet disposed within the pin cavity, wherein the collet is segmented to enable the collet to expand, wherein the collet has a conical cavity, and (iv) a spring disposed within the pin cavity and biasing the collet in a distal direction;
providing an adapter configured to be coupled to a tooling arm, wherein the adapter comprises: (i) a cylindrical body portion that has a lateral recess, and (ii) an adapter pin comprising a conical tip;
aligning the lateral recess of the adapter with the transversal opening of the receiver;
moving the adapter transversely such that the lateral recess of the adapter passes through the transversal opening of the receiver body to position the adapter within the receiver body and align the adapter pin with the pin cavity of the receiver body; and
pushing the adapter in a proximal direction within the receiver, thereby inserting the adapter pin into the pin cavity of the receiver body, such that the conical tip of the adapter pin is received within the conical cavity of the collet and the adapter pin pushes the collet in the proximal direction against the spring, causing the collet to expand such that an exterior surface of the collet is pushed against an interior surface of the receiver body bounding the pin cavity, securing the collet in-position and reducing looseness between the adapter and receiver.

19. The method of claim 18, wherein the adapter pin is a first adapter pin, wherein the pin cavity is a first pin cavity, wherein the spring is a first spring, wherein the collet is a first collet, wherein the adapter further comprises a second adapter pin, wherein the second adapter pin has a respective conical tip, wherein the receiver body comprises a second pin cavity having a second spring and a second collet disposed therein, wherein the second spring biases the second collet in the distal direction, wherein the second collet is segmented to enable the second collet to expand, wherein the second collet has a respective conical cavity, wherein the method further comprises:
aligning the second adapter pin with the second pin cavity of the receiver body; and
inserting the second adapter pin into the second pin cavity of the receiver body as the adapter is pushed in the proximal direction within the receiver, such that the respective conical tip of the second adapter pin is received within the respective conical cavity of the second collet and the second adapter pin pushes the second collet in the proximal direction against the second spring, causing the second collet to expand such that an exterior surface of the second collet is pushed against the interior surface of the receiver body bounding the second pin cavity, securing the second collet in-position and reducing looseness between the adapter and receiver.

20. The method of claim 18, wherein the spring is a first spring, wherein the receiver further comprises a split ring bushing and a second spring biasing the split ring bushing in the distal direction, wherein the split ring bushing has a split that enables the split ring bushing to expand, wherein the split ring bushing has a tapered interior surface, wherein the cylindrical body portion of the adapter has a tapered proximal end, and wherein the method further comprises:
as the adapter is pushed in the proximal direction within the receiver, inserting the tapered proximal end of the cylindrical body portion of the adapter into the split ring bushing such that tapered proximal end interfaces with the tapered interior surface of the split ring bushing, causing the split ring bushing to expand against an interior surface of the receiver, thereby securing the split ring bushing in-position and reducing looseness between the adapter and receiver.
